(19) United States
(12) Patent Application Publication
(10) Pub. No.: US 2007/0074939 A1
(43) Pub. Date: Apr. 5, 2007

(54) Hydraulic type shock-absorbing front fork

(75) Inventor: Hui-Hsiung Chen, Taichung (TW)

Correspondence Address: BACON & THOMAS, PLLC, 625 SLATERS LANE, FOURTH FLOOR, ALEXANDRIA, VA, 22314, US

(73) Assignee: SPINNER INDUSTRY CO., LTD., TAICHUNG (TW)

(21) Appl. No.: 11/296,220

(22) Filed: Dec. 8, 2005

(30) Foreign Application Priority Data
Sep. 30, 2005 (TW) 94217055

(51) Int. Cl. F16F 9/24

(52) U.S. Cl. 188/297; 188/322.17

(57) ABSTRACT

A hydraulic type shock-absorbing front fork used in a bicycle includes a locking mechanism fixedly mounted in the upper fork tube of the front fork, a main adjustment unit mounted in the top end of the upper fork tube of the front fork and adjustable to allow or not allow the hydraulic fluid to pass through the locking mechanism, and a fine adjustment unit mounted in the top end of the upper fork of the front for regulating the range of transient release of pressure during the lockout mode of the front fork to provide a comfortable riding to the user.

### BACKGROUND OF THE INVENTION

1. Field of the Invention

The present invention relates a bicycle front fork shock-absorbing structure and more particularly, to a hydraulic type shock-absorbing front fork.

2. Description of the Related Art

FIG. 1 shows a front fork 1 for bicycle that achieves the designed shock absorbing effect by means of controlling the flowing speed of the internal hydraulic fluid 2.

As illustrated, the upper fork tube 3 has filled therein the hydraulic fluid 2 and mounted therein a flow speed control mechanism, which comprises an adjustment device 4 and a flow interceptor 5. The flow interceptor 5 is affixed to the inside wall of the upper fork tube 3, having an overflow vent 5a and a tapered inner surface 5b. The adjustment device 4 comprises a plug 4a fastened to the top end of the upper fork tube 3, a rotary knob 4 disposed outside the plug 4a, a control rod 4c, which has one end connected to the rotary knob 4 through a screw joint and the other end extending through the plug 4a and the overflow vent 5a of the flow interceptor 5 and fixedly mounted with a stopper 4d. The stopper 4d has a tapered outer surface 4c facing the tapered inner surface 5b.

When rotating the rotary knob 4b clockwise or counter-clockwise the control rod 4c is moved vertically upwards or downwards. When lifting the control rod 4c, the tapered outer surface 4c is approaching the tapered inner surface 5b. On the contrary, when lowering the control rod 4c, the tapered outer surface 4c is moving apart from the tapered inner surface 5b. By means of adjusting the gap between the tapered inner surface 5b and the tapered outer surface 4c, the flow rate and speed of the hydraulic fluid 2 that passes through the flow interceptor 5 are controlled, thereby obtaining the desired buffer effect.

The aforesaid flow speed control mechanism achieves the expected buffer effect, however simply using the rotary knob 4b to move the control rod 4c and to further control the gap between then the tapered inner surface 5b and the tapered outer surface 4c is less precise on flow rate and flow speed control. Further, when the bicycle is moving over a sharply curved uneven road surface area after the tapered inner surface 5b and the tapered outer surface 4c have been closely attached together to lock out the hydraulic fluid 2, a heavy impact may be produced transiently against the parts of the flow speed control mechanism, causing loosening of the parts or damage to the parts.

### SUMMARY OF THE INVENTION

The present invention has been accomplished under the circumstances in view. It is therefore the main object of the present invention to provide a hydraulic type shock absorbing front fork, which precisely controls the flow rate and speed of the hydraulic fluid. It is another object of the present invention to provide a hydraulic type shock absorbing front fork, which releases the pressure upon a sudden impact during the lockout mode, preventing damage to the parts.

To achieve these and other objects of the present invention, the hydraulic type shock absorbing front fork comprises an upper fork tube, the upper fork tube having a top end and a bottom end; a bottom fork tube axially slidably coupled to the bottom end of the upper fork tube; a hydraulic fluid movable in between the upper fork tube and the bottom fork tube; a locking mechanism immovably mounted inside the upper fork tube below the fluid level of the hydraulic fluid and dividing the upper fork tube into an upper fluid chamber and a lower fluid chamber, the locking mechanism comprising a valve body, the valve body having an inlet for allowing the hydraulic fluid to pass from the lower fluid chamber to the upper fluid chamber and at least one return hole for allowing the hydraulic fluid to pass from the upper fluid chamber to the lower fluid chamber; a main adjustment unit, the main adjustment unit comprising a rotary knob and a control shaft, the rotary knob being disposed above the top end of the upper fork tube for rotation by the user to move the control shaft of the main adjustment unit to close/open the inlet, the control shaft of the main adjustment unit having an axial center through hole in communication with the inlet of the locking mechanism, a shoulder disposed in the axial center through hole, and at least one side hole in communication between the axial center through hole and the upper fluid chamber; and a fine adjustment unit, the fine adjustment unit comprising an adjustment knob disposed above the top end of the upper fork tube, a control shaft mounted in the axial center through hole of the control shaft of the main adjustment unit and coupled to the adjustment knob and movable axially in the axial center through hole upon a rotary motion of the adjustment knob, a stopper, and a spring that imparts a pressure to the stopper to force the stopper against the shoulder in the control shaft of the main adjustment unit and to further block the inlet from the at least one side hole of the control shaft of the main adjustment unit.

### BRIEF DESCRIPTION OF THE DRAWINGS

FIG. 1 is a sectional view of a front fork according to the prior art.

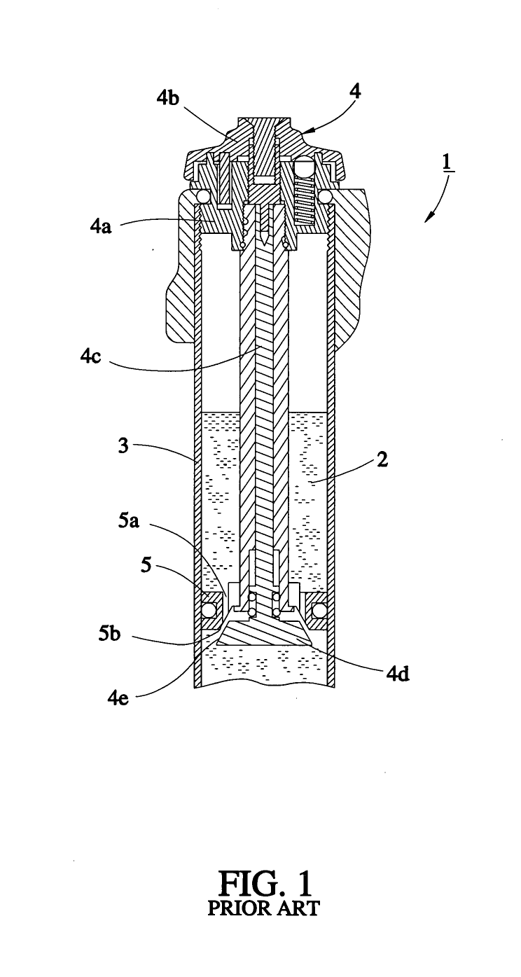

FIG. 2 is a sectional view of a hydraulic type shock absorbing front fork according to the present invention.

FIG. 3 is an exploded view of a part of the present invention.

FIG. 4 is an exploded view of the main adjustment unit and the fine adjustment unit according to the present invention.

FIG. 5 is an enlarged view of the upper part of FIG. 2, showing the front fork under the lockout mode.

FIG. 6 is a similar to FIG. 5, showing the lockout status of the lockout valve and upward displacement of the piston and the stopper upon an impact.

FIG. 7 is similar to FIG. 5, showing the stopper opened, the piston and the lockout valve moved upwards.

FIG. 8 is similar to FIG. 5, showing the control shaft of the fine adjustment unit moved inwards relative to the lockout valve.

### DETAILED DESCRIPTION OF THE INVENTION

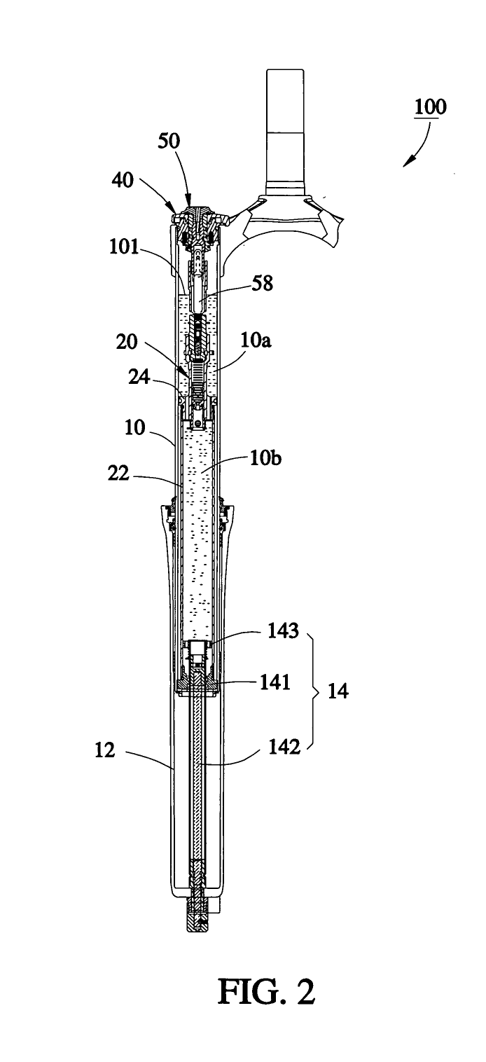

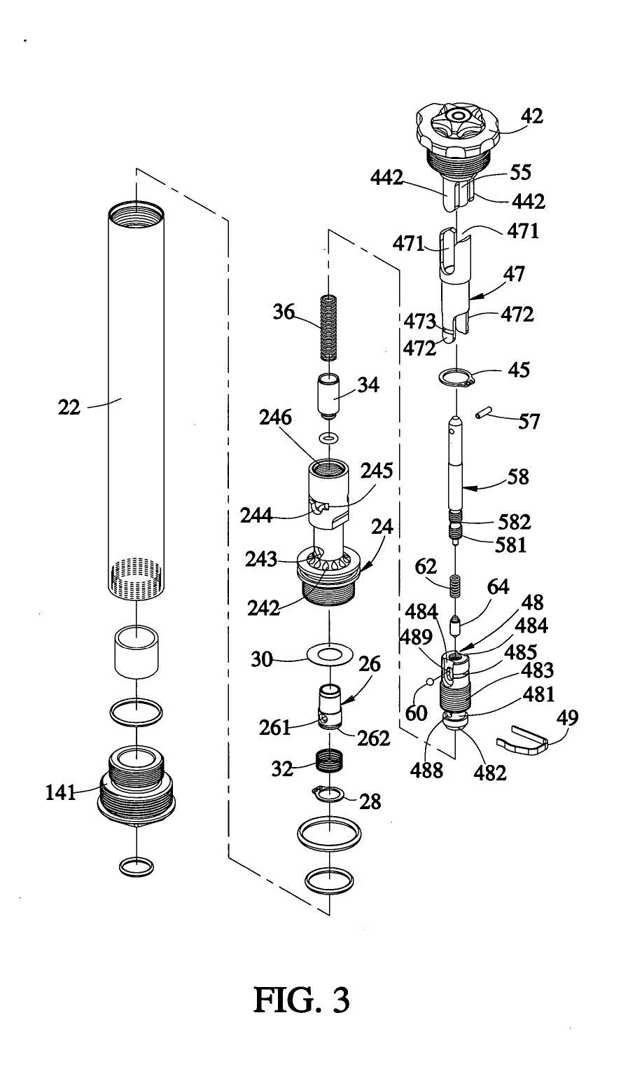

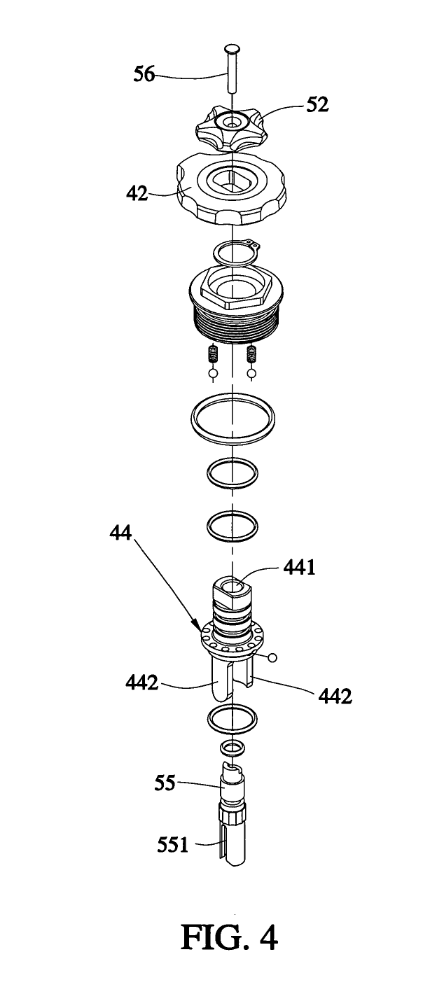

Referring to FIGS. 2-5, a hydraulic type shock absorbing front fork 100 in accordance with the present invention is adapted for use in a bicycle, and can control the flow rate and speed of the hydraulic fluid 101 therein and release the pressure during the lockout mode to prevent damage.

The hydraulic type shock absorbing front fork 100 comprises an upper fork tube 10 and a bottom fork tube 12 axially coupled together to hold the hydraulic fluid 101, a damper 14, a locking mechanism 20, a main adjustment unit 40, and a fine adjustment unit 50. The damper 14 comprises an end plug 141, an axle 142, and a piston 143. The end plug 141 is fastened to the bottom end of the upper fork tube 10. The axle 142 has a bottom end connected to the bottom fork tube 12 and a top end inserted through the end plug 141. The piston 143 is fastened to the to the top end of the axle 142 and suspending inside the upper fork tube 10. When the bicycle is running over an uneven road surface to cause a relative movement between the upper fork tube 10 and the bottom fork tube 12, the hydraulic fluid 101 is forced to move by the piston 143.

The locking mechanism 20 comprises an inner tube 22, a valve body 24, a socket 26, a retaining ring 28, a valve flap 30, a first spring 36, a second spring 32, and a piston 34.

The inner tube 22 has one end fastened to the end plug 141 of the damper 14 through a screw joint and the other end fastened to the valve body 24 through a screw joint, supporting the valve body 24 immovably inside the upper fork tube 10.

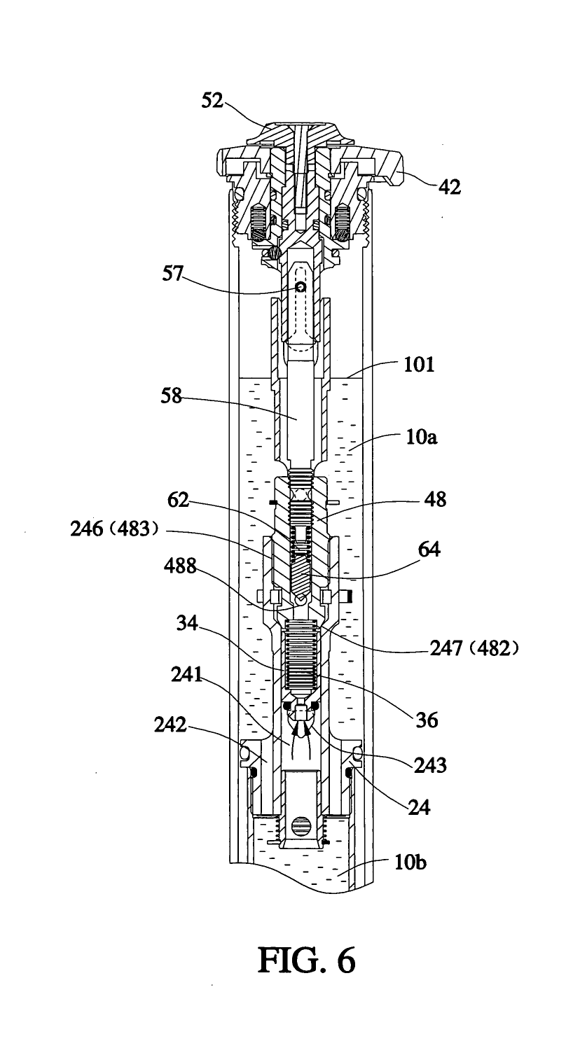

The valve body 24 divides the inside space of the upper fork tube 10 into an upper fluid chamber 10a and a lower fluid chamber 10b, having an inlet 241 (see FIG. 6) for allowing the hydraulic fluid 101 to pass from the lower fluid chamber 10b to the upper fluid chamber 10a, a plurality of return holes 242 for allowing the hydraulic fluid 101 to flow backwards from the upper fluid chamber 10a to the lower fluid chamber 10b, two side holes 243 and two radial through holes 244 symmetrically disposed at two sides at different elevations in communication between the inlet 241 and the upper fluid chamber 10a (only one side hole and one radial through hole are shown), which side holes 243 having an opening gradually increasing in direction from the side close to the bottom hydraulic fluid chamber 10b toward the upper hydraulic fluid chamber 10a, two peripheral grooves 245 respectively extending across the radial through holes 244, an inner thread 246 formed in the top end of the inlet 241, and a shoulder 247 formed in the inlet 241 below the inner thread 246.

The socket 26 is press-fitted into the inlet 241 of the valve body 24, having two holes 261 and a locating groove 262 extending around the periphery near the bottom side. The retaining ring 28 is fastened to the locating groove 262.

The valve flap 30 and the second spring 32 are mounted around the periphery of the socket 26. The second spring 32 is stopped between the retaining ring 28 and the valve flap 30, supporting the valve flap 30 in the operative position where the valve flap 30 blocks the return holes 242 of the valve body 24.

The piston 34 is mounted in the inlet 241 of the valve body 24 and forced downwards by the first spring 36 to touch the socket 26 and to simultaneously block the two side holes 243.

The main adjustment unit 40 comprises a rotary knob 42, a bottom block 44, a control shaft 46, and a spring clamp 49.

The rotary knob 42 is disposed above the top end of the upper fork tube 10. The bottom block 44 is rotatable by the rotary knob 42, having a through hole 441 and two bottom drive rods 442.

The control shaft 46 comprises a cylindrical transmission member 47, and a lockout valve 48. The transmission member 47 has two recessed top receiving portions 471 coupled to the bottom drive rods 442 of the bottom block 44, two symmetrical bottom extension strips 472, and a locating groove 473 respectively formed on the periphery of the bottom extension strips 472.

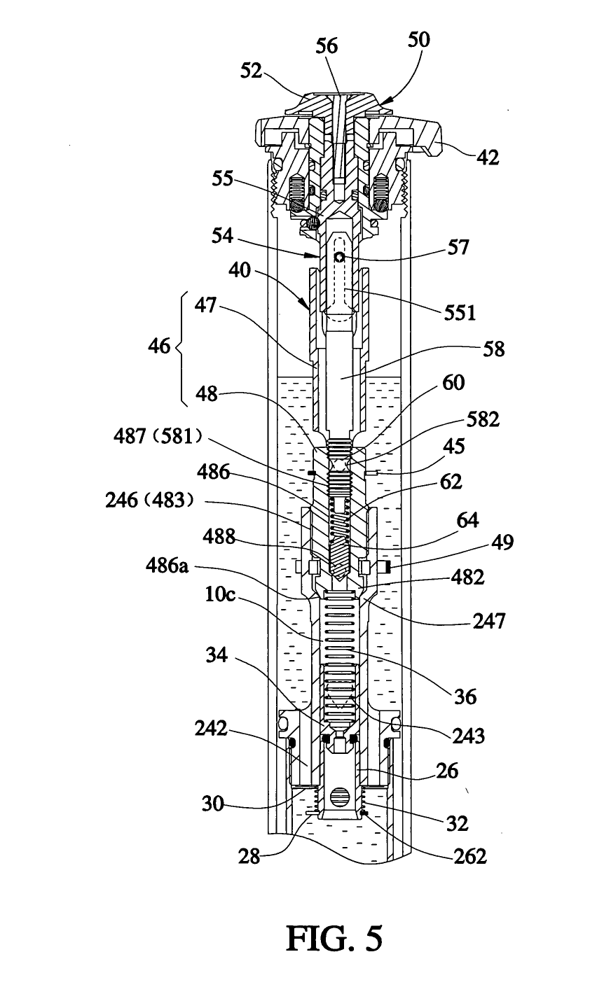

The lockout valve 48 has two coupling grooves 484 respectively coupled to the bottom extension strips 472 of the transmission member 47, two locating grooves 485 extending around the periphery and connected between the two coupling grooves 484 at two opposite sides, an outer thread 483 extending around the periphery below the elevation of the coupling grooves 484, a bottom cone head 481 for contacting the shoulder 247 of the valve body 24 (see FIG. 5), a neck 482 connected between the outer thread 483 and the bottom cone head 482, an axial center through hole 486, which extends axially through the top and bottom ends thereof, a screw hole 487 in one end of the axial center through hole 486, two side holes 488 symmetrically formed in the neck 481 at two sides in communication between the axial center through hole 486 and the upper fluid chamber 10a, an elongated slot 489 longitudinally formed in one coupling groove 484 in communication between the screw hole 487 and the upper fluid chamber 10a, and a shoulder 486a formed in the axial center through hole 486 near the bottom. Further, a fluid chamber 10c is defined between the bottom side of the lockout valve 48 and the piston 34. Further, a C-shaped retainer 45 is fastened to the locating groove 473 and the locating groove 485 to secure the transmission member 47 and the lockout valve 48 together.

The spring clamp 49 is fastened to the peripheral grooves 245 of the valve body 24 and the neck 481 of the lockout valve 48 to secure the lockout valve 48 to the valve body 24. The width of the neck 481 is slightly greater than the width of the spring clamp 49 so that the lockout valve 48 is movable relative to the valve body 24 within a limited range subject to the vertical length of the neck 481.

The fine adjustment unit 50 comprises an adjustment knob 52, a control shaft 54, a steel ball 60, a spring 62, and a stopper 64.

The adjustment knob 52 is supported on the top side of the rotary knob 42.

The control shaft 54 comprises an adjustment rod 55, a bolt 56, a pin 57, and a driven rod 58.

The adjustment rod 55 is inserted through the through hole 441 of the bottom block 44 and fastened to the rotary knob 42 with the bolt 56, having two longitudinal slots 551. The pin 57 is transversely inserted through the top end of the driven rod 58 with the two ends respectively coupled to the longitudinal slots 551. The driven rod 58 has a bottom outer thread 581 threaded into the screw hole 487 of the lockout valve 48 and a locating groove 582 extending around the periphery near the bottom end.

The steel ball 60 is put in the elongated slot 489 of the lockout valve 48 after connection of the driven rod 58 to the lockout valve 48 and before connection of the bottom extension strips 472 of the transmission member 47 to the coupling grooves 484 of the lockout valve 48. After mounting of the C-shaped retainer 45 in the locating groove 473 and the locating groove 485 to secure the transmission member 47 and the lockout valve 48 together, the steel ball 60 is stopped in the elongated slot 489 by the bottom extension strips 472 and partially engaging into the locating groove 582 of the driven rod 58 to stop the driven rod 58 from axial movement.

The spring 62 and the stopper 64 are set in the axial center through hole 486 of the lockout valve 48 before connection of the driven rod 58 to the lockout valve 48. The spring 62 has one end stopped against the driven rod 58 and the other end stopped against the stopper 64 to force the stopper 64 into contact with the shoulder 486a and to block the side holes 488.

The above statement describes the component parts of the hydraulic type shock absorbing front fork 100 and their relative positioning. The buffering action and the control of the flow speed rate and flow speed of the hydraulic fluid are outlined hereinafter.

FIG. 5 shows the lockout status of the front fork 100. Under this mode, the bicycle is suitable for running on a slope or a smooth road area for a long distance at a high efficiency. At this time, the piston 34 touches the socket 26, the cone head 482 of the lockout valve 48 of the main adjustment unit 40 touches the shoulder 247 of the valve body 24, and the front end of the stopper 64 touches the shoulder 486a of the lockout valve 48.

Referring to FIG. 6, when a sudden impact is produced as the bicycle is moving over an obstacle (a stone or cave) on the road under the lockout mode, the hydraulic fluid pressure in the fluid chamber 10c above the piston 34 surpasses the predetermined spring force of the spring 62. Therefore, the stopper 64 is moved upwards at this time, and the hydraulic fluid 101 moves the piston 34 rapidly and at the same time flows through the through hole 243 of the valve body 24 and the side holes 488 of the lockout valve 48 into the upper fluid chamber 10a to release the pressure transiently. When passed over the obstacle, the springs 36 and 62 respectively push the piston 34 and the stopper 64 back to the lockout status. During the aforesaid process, the front fork 100 can still release the pressure transiently during the lockout mode when encountered an impact due to an obstacle on the road, preventing damage or loosening of the internal parts of the front fork 100.

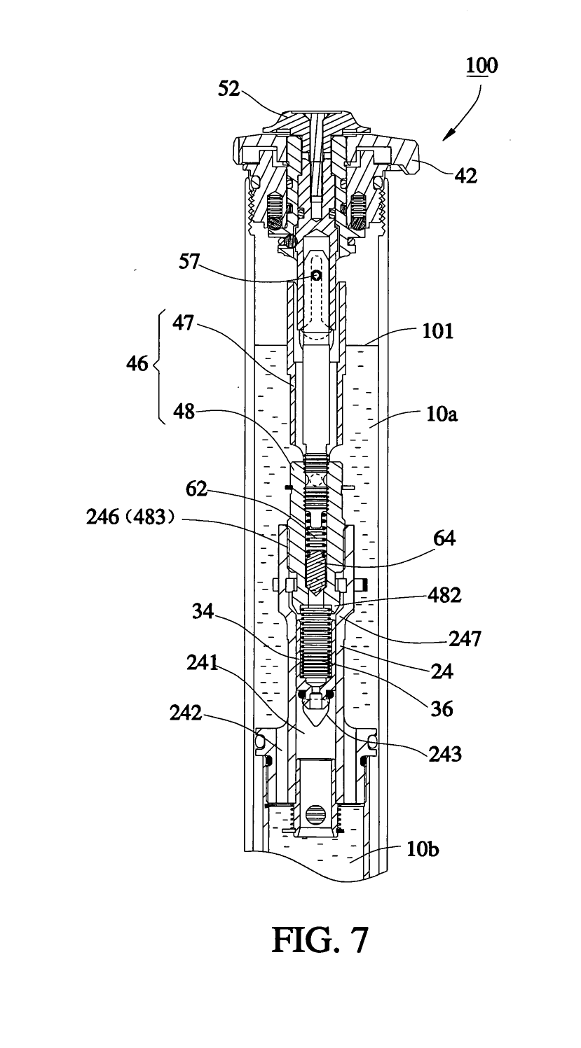

FIG. 7 shows the front fork 100 set in the mode of being capable of producing a buffering effect for enabling the bicycle rider to ride the bicycle on an uneven rod surface for a long distance comfortably. In order to achieve this object, the bicycle rider rotates the rotary knob 42 to move the lockout valve 48, leaving a gap between the cone head 482 and the shoulder 247 of the valve body 24. At this time, the hydraulic fluid 101 is in an open status and allowed to pass through the locking mechanism 20. When the bicycle is moving on an uneven road surface, the piston 34 is forced upwards by the hydraulic fluid 101, allowing a part of the hydraulic fluid 101 to pass through the aforesaid gap to the upper fluid chamber 10a. Because side holes 243 have an opening gradually increasing in direction from the side close to the bottom hydraulic fluid chamber 10b toward the upper hydraulic fluid chamber 10a, the flow rate and speed of the hydraulic fluid passing through the side holes 243 are gradually increasing during upward displacement of the piston 34 to fork with the viscous characteristic of the hydraulic fluid 101, thereby achieving the desired buffering effect.

Further, the K value of the coefficient of elasticity of the spring 62 surpasses the K value of the coefficient of elasticity of the spring 36. Therefore, unless encounters a sharp geographic change on the road, for example, a cave on the road, the stopper 64 is normally kept in the lockout status.

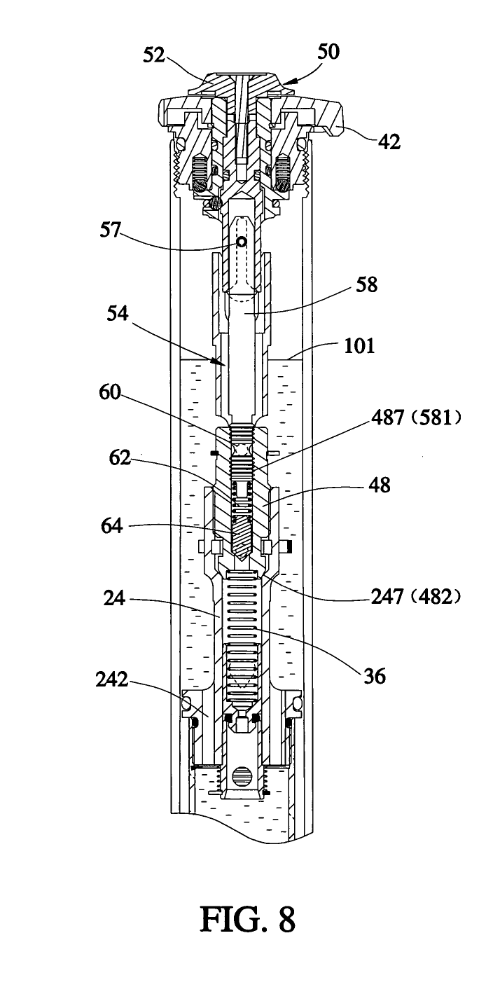

Further, the bicycle rider can also operate the adjustment knob 52 to move the control shaft 54 inwards or outwards relative to the lockout valve 48 to further change the spring force of the spring 62. FIG. 8 shows the control shaft 54 moved inwards relative to the locknut 48. At this time, the spring forced of the spring 62 is relatively increased, and the hydraulic fluid 101 must impart a relatively greater upward push force to move the piston 64, i.e., the piston 64 will be moved upwards under this mode only when the bicycle is moving over an obstacle on the road. FIG. 5 shows the control shaft 54 moved outwards relative to the lockout valve 48 and the spring force of the spring 62 is relatively reduced, and therefore the piston 64 can relatively easily be moved upwards by the hydraulic fluid 101. As stated above, the find adjustment unit 50 allows the user to adjust the range of the transient relief of the pressure when the front fork 100 is under the lockout mode. Therefore, the invention allows accurate adjustment of the damping resistance to fit different road conditions.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A hydraulic type shock-absorbing front fork comprising:
an upper fork tube, said upper fork tube having a top end and a bottom end;
a bottom fork tube axially slidably coupled to the bottom end of said upper fork tube;
a hydraulic fluid movable in between said upper fork tube and said bottom fork tube;
a locking mechanism immovably mounted inside said upper fork tube below the fluid level of said hydraulic fluid and dividing said upper fork tube into an upper fluid chamber and a lower fluid chamber, said locking mechanism comprising a valve body, said valve body having an inlet for allowing said hydraulic fluid to pass from said lower fluid chamber to said upper fluid chamber and at least one return hole for allowing said hydraulic fluid to pass from said upper fluid chamber to said lower fluid chamber;
a main adjustment unit, said main adjustment unit comprising a rotary knob and a control shaft, said rotary knob being disposed above the top end of said upper fork tube for rotation by the user to move said control shaft of said main adjustment unit to close/open said inlet, the control shaft of said main adjustment unit having an axial center through hole in communication with said inlet of said locking mechanism, a shoulder disposed in said axial center through hole, and at least one side hole in communication between said axial center through hole and said upper fluid chamber; and
a fine adjustment unit, said fine adjustment unit comprising an adjustment knob disposed above the top end of said upper fork tube, a control shaft mounted in the axial center through hole of the control shaft of said main adjustment unit and coupled to said adjustment knob and movable axially in said axial center through hole upon a rotary motion of said adjustment knob, a stopper, and a spring that imparts a pressure to said stopper to force said stopper against the shoulder in the control shaft of said main adjustment unit and to further block said inlet from said at least one side hole of the control shaft of said main adjustment unit.

2. The hydraulic type shock-absorbing front fork as claimed in claim 1, wherein:
said valve body of said locking mechanism has a shoulder in said inlet;
said main adjustment unit further comprises:
a bottom block coupled between said rotary knob and the control shaft of said main adjustment unit and rotatable by said rotary knob to rotate the control shaft of said main adjustment unit, said bottom block having a through hole;
the control shaft of said main control unit has a screw hole in the axial center through hole thereof, and a head for contacting the shoulder in said inlet of said valve body;
the control shaft of said fine adjustment unit is inserted through the through hole of said bottom block, having an outer thread threaded into the screw hole of the control shaft of said main adjustment unit.

3. The hydraulic type shock-absorbing front fork as claimed in claim 2, wherein the control shaft of said fine adjustment unit comprises an adjustment rod coupled to said adjustment knob, said adjustment rod having a longitudinal slot, a driven rod, and a pin transversely fastened to said driven rod and coupled to said longitudinal slot to guide movement of said driven rod along said longitudinal slot, said driven rod having an outer thread.

4. The hydraulic type shock-absorbing front fork as claimed in claim 3, wherein the control shaft of said main adjustment unit comprises a transmission member coupled to said bottom block and rotatable by said bottom block, and a lockout valve connected to said transmission member, said lockout valve having the axial center through hole, screw hole, at least one side hole and shoulder of the shaft of said main adjustment unit formed therein and a longitudinal slot in communication with the screw hole; the driven rod of said fine adjustment unit has a locating groove extending around the periphery; said fine adjustment unit further comprises a ball put in the longitudinal slot of said lockout valve and the locating groove around the periphery of said driven rod.

5. The hydraulic type shock-absorbing front fork as claimed in claim 4, wherein said valve body has at least one peripheral groove; said lockout valve has a neck; said main adjustment unit further comprises a spring clamp fastened to the at least one peripheral groove of said valve body and the neck of said lockout valve to secure said lockout valve to said valve body, said neck having a width greater than the width of said spring clamp.

6. The hydraulic type shock-absorbing front fork as claimed in claim 5, wherein said valve body of said locking mechanism has at least one through hole in communication between said inlet and said upper fluid chamber; said locking mechanism further comprises a piston mounted in said inlet of said valve body, a socket press-fitted into said inlet of said valve body for stopping said piston, said socket having at least one hole and a locating groove extending around the periphery thereof, a retaining ring fastened to the locating groove of said socket, a first spring mounted in said inlet of said valve body and imparting a pressure to said piston to force said piston into contact with said socket and to further block the at least one side hole of said valve body, a valve flap mounted around the periphery of said socket, and a second spring stopped between said retaining ring and said valve flap to force said valve flap to block the at least one return hole of said valve body.

7. The hydraulic type shock-absorbing front fork as claimed in claim 6, wherein the at least one side hole of said valve body has an opening gradually increasing in direction from said lower fluid chamber toward said upper fluid chamber.
